(19) United States
(12) Patent Application Publication
(10) Pub. No.: US 2013/0021008 A1
(43) Pub. Date: Jan. 24, 2013

(54) POWER CONVERTER APPARATUS AND METHOD WITH COMPENSATION FOR LIGHT LOAD CONDITIONS

(71) Applicants: Robert Jay Hume, Brier, WA (US); Barry F. Waltman, Bothell, WA (US); Stefan Jon Kristjansson, Shoreline, WA (US); Jay Allen Kuehny, Sammamish, WA (US); Yan Lu, Sammamish, WA (US); Bertrand Nkei, Redmond, WA (US)

(72) Inventors: Robert Jay Hume, Brier, WA (US); Barry F. Waltman, Bothell, WA (US); Stefan Jon Kristjansson, Shoreline, WA (US); Jay Allen Kuehny, Sammamish, WA (US); Yan Lu, Sammamish, WA (US); Bertrand Nkei, Redmond, WA (US)

(21) Appl. No.: 13/185,142

(22) Filed: Jul. 18, 2011

(51) Int. Cl. G05F 1/00

(52) U.S. Cl. 323/271

(57) ABSTRACT

A switch mode power converter provides high efficiency at light and no load conditions by utilizing a variable inductance swinging choke at the output of a synchronous rectifier. The use of the swinging choke with a synchronous rectifier eliminates power inefficiencies caused by currents that circulate from the output capacitance to the input capacitance during no load conditions.

### BACKGROUND

1. Technical Field

This disclosure is generally related to power converters, and is more particularly related to regulated power converters.

2. Description of the Related Art

Power converters are used to transform electrical energy, for example converting between alternating current (AC) and direct current (DC), adjusting (e.g., stepping up, stepping down) voltage levels and/or frequency.

Power converters take a large variety of forms. One of the most common forms is the switched-mode power converter or supply. Switched-mode power converters employ a switching regulator to efficiently convert voltage or current characteristics of electrical power. Switched-mode power converters typically employ a storage component (e.g., inductor, transformer, capacitor) and a switch that quickly switches between full ON and full OFF states, minimizing losses. Voltage regulation may be achieved by varying the ratio of ON to OFF time or duty cycle. Various topologies for switched-mode power converters are well known in the art including non-isolated and isolated topologies, for example boost converters, buck converters, synchronous buck converters, buck-boost converters, and fly-back converters.

In the interest of efficiency, digital logic technology is employing ever lower voltage logic levels. This requires power converters to deliver the lower voltages at higher currents level. To meet this requirement, power converters are employing more energy efficient designs. Power converters are also increasingly being located in close proximity to the load as point of load (POL) converters in a POL scheme. These power converters must generate very low voltage levels (e.g., less than 1V) at increasingly higher current levels (e.g., greater than 10 A). The ability to supply these relatively high current levels may come at the cost of inefficiencies during light and no load conditions.

Power converters which implement synchronous rectifiers to regulate the output voltage are susceptible to power inefficiencies caused by circulating currents during light and no load conditions. Circulating currents are currents that flow from the load back through the converter during light and no load conditions. The high side active switch of the synchronous rectifier compensates for the back flow of current when the high side active switch is turned ON. The current passes through lossy system components, e.g., traces and transistor channels, and dissipates power through the parasitic resistances in accordance with P_{dissipation}=I²R_{parasitic}. Thus, current circulating from the output back into the synchronous rectifier of a power converter results in an inefficient power loss.

New approaches to providing power converters which can improve the inefficiencies caused during light and no load conditions are desirable.

### BRIEF SUMMARY

An existing approach for regulating the output voltage of a buck converter at light and no load conditions when implemented with a lowside switch as a Schottky diode is to replace the output inductor with a swinging choke. This approach is capable of supplying current at light load conditions by allowing the inductance to increase as load decreases and thus maintain forward conduction down to lighter loads. Applicants have recognized that this approach eventually requires the high side transistor to pulse skip or completely shut off to maintain output regulation otherwise at a critical light load constant conduction will become discontinuous. The common solution of pulse skipping or shutting off the converter causes negative side-effects such as increased electro-magnetic interference (EMI) and reduced load range. Applicants have also recognized that this approach may require extra sensing circuitry to determine when discontinuous conduction mode is reached. Additionally, this approach is less efficient than using a low side active switch because more power is dissipated in a forward biased diode than in a low side active switch during normal operating conditions. In particular, power dissipating in the diode is determined by the voltage drop clamped across the forward-biased diode multiplied by the current flowing through the diode (P=I*V_{diode}). In contrast, the power dissipated in the low side active switch is determined by the square of the current flowing through the switch multiplied by the channel resistance Rds.

Another existing approach includes preloading an output inductor of a power converter with a resistor. Applicants have recognized that at light loads the resistor may continue to provide a discharge path for the current supplied to the output inductor, allowing lighter load continuous conduction at the expense of greater power loss and thus lower efficiency, especially at light and no load conditions.

The use of synchronous rectification for low output voltage converters does not suffer the same problem of the inductor current becoming discontinuous at light and no load conditions because the low side active switch does not clamp the inductor at a specific voltage. Instead, reversed circulating currents in the inductor are allowed to flow which unlike a diode clamp do not disrupt converter stability and are thus commonly ignored but these currents do lead to inefficiencies at light and no load conditions.

An approach described here results in a power converter with higher efficiency at light and no load conditions than existing approaches.

The approach described herein utilizes the varying inductance of a swinging choke with a synchronous rectifier to reduce the effects of circulating currents that arise during light and no load conditions, i.e., as the current demands at the load approach zero.

A power converter may be summarized as including a high side active switch; a low side active switch electrically coupled to the high side active switch at a node; an inductor that has an inductance that varies as a function of current flow through the inductor, the inductor coupled between an output voltage terminal and the node between the high and the low side switches; and a controller coupled to control the high and the low side active switches to regulate an output voltage provided by the power converter, wherein the high side active switch is selectively operable in response to the controller to electrically couple the output voltage terminal to an input voltage terminal through the inductor, and the low side active switch is selectively operable in response to the controller to electrically couple the output terminal to a ground of the power converter through the inductor. The inductor, the high side and the low side active switches configured as a synchronous buck converter. The inductor may be a swinging choke. The controller may be an oscillator driven pulse width modulator configured to operate the high side active switch and the low side active switch based on a duty cycle that is dependent upon an average of the quantity of current supplied to the output terminal. The high side active switch and the low side active switch may be metal oxide semiconductor field effect transistors (MOSFETs).

The power converter may optionally further include a resistor coupled to the output terminal to preload the inductor with a portion of the current flow through the inductor, wherein the inductor is positioned between the resistor and the low side active switch

A power converter may be summarized as including at least one input terminal; at least one output terminal; a synchronous buck converter circuit electrically coupled between the at least one input and the at least one output terminals, including at least a first active switch, a second active switch and a swinging choke coupled between the at least one output terminal and the first and the second active switches; and a controller coupled to control the first and the second active switches to regulate an output voltage provided by the power converter. The swinging choke may include a core formed of a number of pieces with a number of windings. The core may include a pair of outer legs and a optionally a center leg. Complimentary portions forming one or more of the legs may include a stepped gap therebetween. The first active switch may be a P-channel metal oxide field effect transistor (MOSFET), the second active switch may be an N-channel MOSFET and the swinging choke may be electrically coupled between a drain of the P-channel MOSFET and a drain of the N-channel MOSFET.

A method of operating a power converter having a high side active switch, a low side active switch and a swinging choke coupled between an output terminal of the power converter and a node between the high and low side active switches may be summarized as including during a first portion of a cycle causing the high side active switch to electrically pass current from an input terminal to an output terminal through the swinging choke to vary an inductance of the swinging choke; and during a second portion of the cycle causing the low side active switch to electrically pass current through the swinging choke from ground to vary the inductance of the swinging choke. The high side active switch may be a high side metal oxide field effect transistor (MOSFET) and causing the high side active switch to electrically pass current includes applying a high side gate drive signal to the high side MOSFET and wherein the low side active switch may be a low side MOSFET and causing the low side active switch to electrically pass current includes applying a low side gate drive signal to the low side MOSFET.

The method may further include in response to a reduction in a level of the current being passed by at least one of the high side or the low side active switches, allowing the inductance of the swinging choke to increase to prevent the current from becoming discontinuous.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are enlarged and positioned to improve drawing legibility. Further, the particular shapes of the elements as drawn, are not intended to represent the actual shape of the particular elements but have been selected for ease of recognition in the drawings.

FIG. 1 is a schematic diagram of a power converter including an inner current loop and an outer voltage loop thereof, according to one illustrated embodiment.

FIG. 2 is a schematic diagram of a power converter including a synchronous rectifier and a variable inductor, according to one illustrated embodiment.

FIGS. 3A-3C are simplified drawings of exemplary swinging choke cores, according to the illustrated embodiments.

FIG. 4 is a flow diagram of a method of operating the power converters of FIGS. 1-2, according to one illustrated embodiment.

FIG. 5 is a flow diagram of an additional method that may be performed as part of the method FIG. 4, according to one illustrated embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with power conversion topologies, controllers, housekeeping circuitry, low voltage lock out, high voltage lock out, and inrush control have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, i.e., as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used in the specification and the appended claims, references are made to a “node” or “nodes.” It is understood that a node may be a pad, a pin, a junction, a connector, a wire, or any other point recognizable by one of ordinary skill in the art as being suitable for making an electrical connection within an integrated circuit, on a circuit board, in a chassis or the like.

The headings and Abstract of the Disclosure provided herein are for convenience only and do not interpret the scope or meaning of the embodiments.

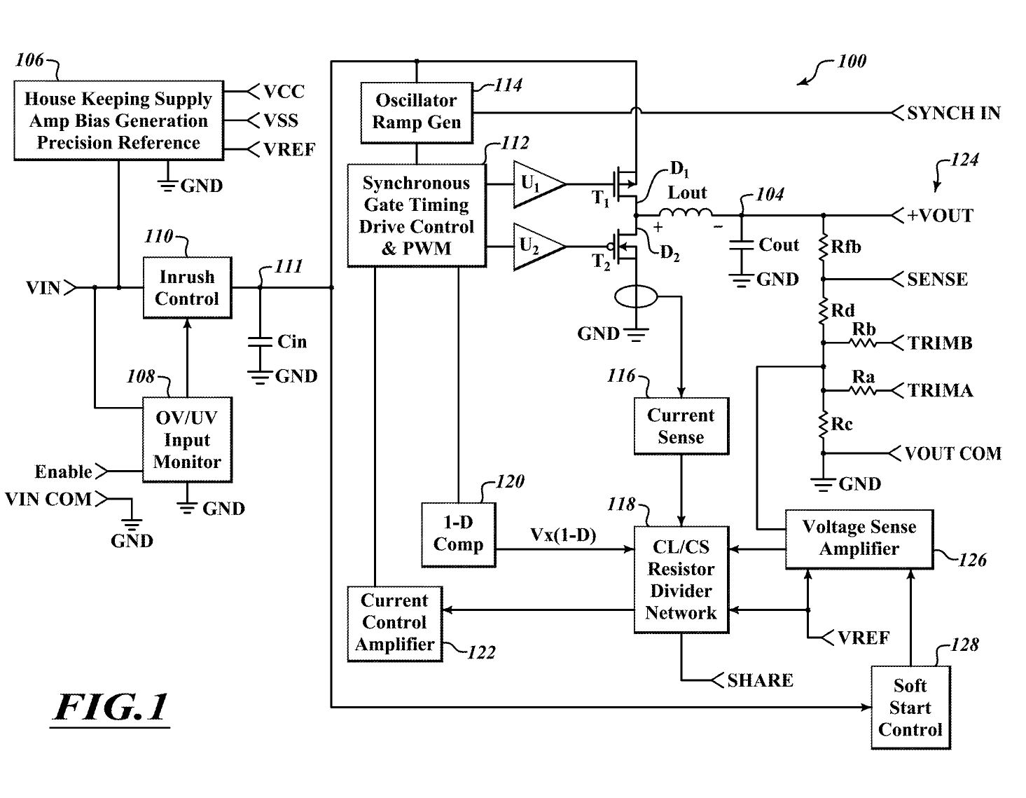

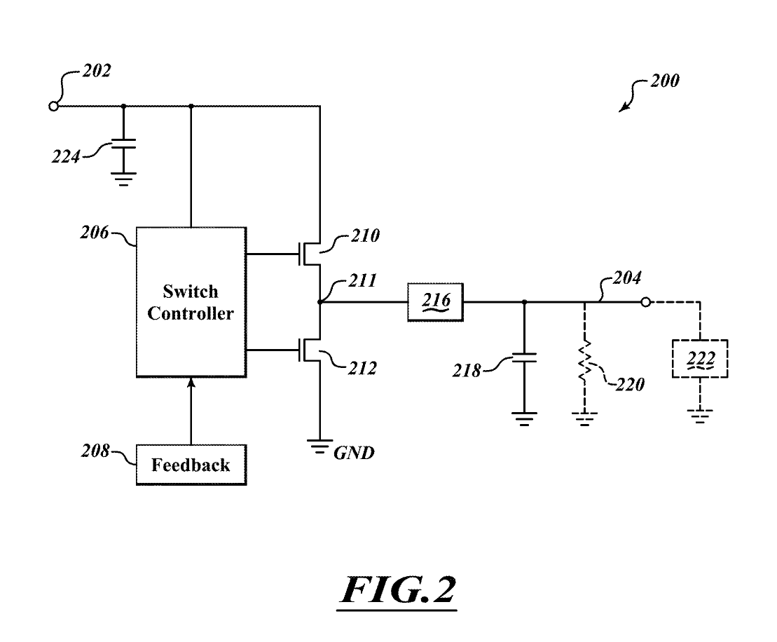

FIG. 1 shows a power converter 100, according to one illustrated embodiment. The description of FIG. 1 provides an overview of the structure and operation of the power converter 100, which structure and operation are described in further detail with reference to FIGS. 2-5.

The power converter 100 may, for example, take the form of a DC/DC power converter to convert (e.g., raise, lower) DC voltages. The power converter 100 may, for example, include an output inductor Lout electrically coupled to an output terminal +VOUT, a first active switch (i.e., high side active switch) T1 selectively operable to electrically couple the inductor Lout to a voltage input terminal VIN. A second device T2 electrically couples the output inductor Lout to a ground GND which is in turn electrically coupled to a ground or common input terminal VIN COM and a ground or common output terminal VOUT COM.

As illustrated, the power converter 100 may advantageously take the form of a synchronous buck converter, operable to lower a DC voltage. Where implemented as a synchronous buck converter, the second device T2 takes the form of a second active switch (i.e., high side active switch), selectively operable to electrically couple the output inductor Lout to ground GND. The power converter 100 may take forms other than a synchronous buck converter, for example a buck converter where the second device takes the form of a passive device, such as a diode (not shown).

The switches T1, T2 may take a variety of forms suitable for handling expected currents, voltages and/or power. For example, the switches T1, T2 make take the form of an active device, such as one or more metal oxide semiconductor field effect transistors (MOSFETs). As illustrated in the Figures, the first or high side switch T1 may take the form of P-Channel MOSFET, while the second or low side switch T2 make take the form of an N-Channel MOSFET. The output inductor Lout may be coupled via a node 102 to the drains D1, D2 of the MOSFET switches T1, T2 respectively. The power converter 100 may employ other types of switches, for example insulated gate bipolar transistors (IGBTs). While only one respective MOSFET is illustrated, each of the first and/or second switches T1, T2 may include two or more transistors electrically coupled in parallel.

The power converter 100 may include an output capacitor Cout electrically coupled between ground GND and a node 104 between the output inductor Lout and the output terminal +VOUT. Output capacitor Cout may smooth the output supplied to the output terminal +VOUT.

On an input side, the power converter 100 may include an auxiliary power supply and voltage reference generation block 106, an over voltage/under voltage monitor block 108 and/or an “inrush” current control block 110.

The auxiliary power supply and voltage reference generation block 106 implements a house keeping supply generation function, amplifier bias generation function and precision reference generation function, resulting in a positive supply voltage or potential VCC, a negative supply voltage or potential or ground VSS, and a precision reference voltage or potential VREF. The structure and operation of the auxiliary power supply and voltage reference generation block 106 can take any existing form, and is not a subject of this application so is not described in further detail.

The over voltage/under voltage monitor block 108 monitors instances of over voltage and/or under voltage conditions, supplying a control signal via a control line (not called out in FIG. 1) to the “in rush” current control block 110 as needed. The over voltage/under voltage monitor block 108 or other components may be triggered via an enable signal via an enable input terminal ENABLE. The “inrush” current control block 110 controls “inrush” current, directly limiting current to input capacitor(s) Cin, reducing electrical stresses on the power converter 100 and any system into which the power converter 100 is incorporated. Power converters 100 typically employ large internal bulk filter capacitors to filter the input power to reduce noise conducted out of the power converter 100, back upstream to the source of the input power. The input capacitor Cin is electrically coupled between ground GND and a node 111 between the “inrush” current control block 110 and the first active switch T1. The “inrush” current control block 110 is configured to control the “inrush” current that flows to the input capacitor, particularly at initial application of the input voltage or potential VIN.

The structure and operation of the over voltage/under voltage monitor block 108, the “inrush” current control block 110, and the input capacitor(s) Cin may take any existing form, and are not subjects of this application so are not described in further detail.

Control of the converter circuit (e.g., synchronous buck converter) is realized via a number of components or assemblies, represented in FIGS. 1 and 2 as blocks.

The power converter 100 includes a synchronous gate timing drive control and pulse width modulation (PWM) block 112 and an oscillator ramp generation block 114. The oscillator ramp generation block 114 generates an oscillating ramp signal and provides the oscillating ramp signal to the synchronous gate timing drive control and pulse width modulation block 112. The oscillator ramp generation block 114 may optionally receive a synchronization signal via a synchronization input terminal SYNC IN, to synchronize operation with one or more other power converters or other devices or systems, for example a clock of a system in which power converter 100 is installed. The synchronous gate timing drive control and pulse width modulation block 112 generates gate control signals to control the switches T1, T2, for example via amplifiers U1, U2, respectively. The synchronous gate timing drive control and pulse width modulation block 112 may optionally receive a share signal via a share input terminal SHARE from one or more other power converters, for example when electrically coupled to a common load for current sharing operation. The structure and operation of the synchronous gate timing drive control and pulse width modulation (PWM) block 112 and the oscillator ramp generation block 114 can take any existing form, and are not subjects of this application, so are not described in further detail.

At a high level, the power converter 100 utilizes an inner current control loop and an outer voltage control loop. The inner current control loop is implemented via a current sense block 116, a current limiting/current sharing (CL/CS) resistor network 118, a 1−D (one minus duty cycle) compensation block 120 and a current control amplifier 122. The outer voltage control loop is implemented by a voltage sense resistor divider network 124 and a voltage error amplifier 126 which feeds the CL/CS resistor network 118 to ultimately control the output voltage or potential of the power converter 100.

With respect to the inner current control loop, the current sense block 116 implements current sensing over a portion of a cycle of the power converter 100, for example over the ON or CLOSED portion of one of the switches T1, T2. The current sense block 116 provides a signal to the CL/CS resistor divider network 118 to control the current control amplifier 122, which signal is indicative of the sensed current. For example, the current sense block 116 may sense current over each portion of a cycle during which portion the low side switch T2 is ON or CLOSED (i.e., conducting), electrically coupling the output inductor Lout to ground GND, while neglecting those portions of the cycle when the low side switch T2 is OFF or OPEN.

Where the output current of the synchronous buck converter circuit in the power converter 100 is sensed at the low side switch (e.g., MOSFET synchronous switch) T2, the average of this sensed current is equal to lo*(1−D), where D is defined as the duty cycle of the high side switch (e.g., MOSFET) T1. Since this signal is dependent on the duty cycle and negative in value, a compensation signal that is a direct function of the duty cycle is scaled via the 1−D compensation block 120, and summed with the sensed current signal by the CL/CS resistor network 118. The resultant signal is optionally level shifted in the CL/CS resistor network 118 to create a level shifted compensated signal. The level shifted compensated signal may then be averaged by the current control amplifier 122, and the averaged signal used to control the output current of the power converter 100.

This approach to current sensing presents both advantages and disadvantages. This current sensing approach may advantageously improve efficiency since only a portion (1−D) of the total output current of the power converter 100 is sensed. Also, the generated sensed current signal is directly referenced to the ground of the circuit, providing a significant simplification of the circuit implementation. However, the derived signal is disadvantageously a direct function of the duty cycle D of the high side switch T1 of the power converter 100. However, this disadvantage may be effectively overcome by a unique approach of summing in a compensation signal V×(1−D) that sufficiently compensates for the duty cycle variation in the sensed current signal. As explained above, the summation of the compensation signal may be accomplished via the CL/CS resistor divider network 118.

The current control amplifier 122 generates control signals based at least on the level shifted compensated signals from the CL/CS resistor divider network 117 to control the synchronous gate timing drive control and pulse width modulation block 112.

With respect to the inner current control loop, the voltage sense resistor network 124 (e.g., resistor Rfb coupled between voltage output terminal +VOUT and sense terminal SENSE, divider resistors Rd, Rc, and trim resistors Rb, Ra coupled to trim terminals TRIMB, TRIMA, respectively) senses voltage or potential at the output terminal +VOUT with respect to the ground terminal VOUTCOM. The voltage sense resistor network 124 supplies a signal indicative of the sensed voltage or potential to the voltage sense amplifier 126. The voltage sense amplifier 126 generates a voltage error signal which indicates a difference between the sensed voltage or potential and a reference voltage or potential. Hence, the voltage sense amplifier 126 is interchangeably referred to herein and in the claims as voltage error amplifier 126. The voltage error amplifier 126 provides the voltage error signal to the current control amplifier 122 via the CL/CS resistor divider network 118, for use in generating the control signals supplied to the synchronous gate timing drive control and pulse width modulation block 112 to control output voltage or potential of the power converter 100.

The power converter 100 may optionally include a soft start control block 128. The soft start control block 128 may receive the precision voltage reference signal VREF from the auxiliary power supply and voltage reference generation block 106. The soft start control block 128 may control various soft start characteristics of the power converter 100, for example soft-start time, current limit thresholds, current limit on-time and output voltage or potential level at which control is handed over to a main control loop. The soft start control block 128 may, for example, provide a progressively increasing pulse width, forming a startup voltage ramp which is proportional to a level of a supply voltage VCC, for instance without the need of an external capacitor. The structure and operation of the soft start control block 128 can take any existing form, and is not a subject of this application so is not described in further detail.

FIG. 2 shows a power converter 200, according to one illustrated embodiment.

The power converter 200 may, for example, take the form of a DC/DC power converter to convert (e.g., raise, lower) DC voltages. In particular, the power converter 200 may advantageously take the form of a synchronous buck converter, as illustrated in FIG. 2, operable to lower a DC voltage. The power converter 200 may, for example, include a swinging choke 216 electrically coupled to an output terminal 204, a first active switch (i.e., high side active switch) 210 selectively operable to electrically couple the swinging choke 216 to a voltage input terminal 202, a second active switch (i.e., low side active switch) 212 selectively operable to electrically couple the swinging choke 216 to ground GND, and a controller 206 operable to activate the switches to regulate the voltage at output terminal 204. Optionally, the power converter 200 may be coupled to supply voltage and current to one or more electronic devices or additional power converters in close proximity to the device(s), (hereinafter device 222), so that the power converter 200 is a point of load (POL) converter.

The switches 210, 212 may take a variety of forms suitable for handling expected currents, voltages and/or power. For example, the switches 210, 212 make take the form of an active device, such as one or more metal oxide semiconductor field effect transistors (MOSFETs). As illustrated in FIG. 2, the high side switch 210 may take the form of P-Channel MOSFET, while the low side switch 212 make take the form of an N-Channel MOSFET. The swinging choke 216 may be coupled via a node 211 to the drains of the MOSFET switches 210, 212 respectively. The power converter 200 may employ other types of switches, for example insulated gate bipolar transistors (IGBTs). While only one respective MOSFET is illustrated, each of the first and/or second switches 210,212 may include two or more transistors electrically coupled in parallel.

The controller 206 may take a variety of forms suitable for regulating the voltage and current at the output terminal 204. The controller 206 may include an oscillator, a pulse width modulator driven by the oscillator, and several comparators to determine a duty cycle by which the switches 210, 212 are driven (i.e., turned ON and OFF). The controller 206 may receive power from the voltage at the input terminal 202. The controller 206 may also receive input from a feedback circuit 208 that may be configured to monitor the output voltage, the output current, or both the output voltage and output current.

The feedback circuit 208, in addition to the controller 206, the switches 210, 212, and the swinging choke 216 form an output regulation loop. The feedback circuit 208 may utilize discrete components, such as resistors, coupled to the output terminal 204 to determine the state or value of the output signals. The controller 206 may regulate the output signals by altering the duty cycle or magnitude of the drive signals applied to the switches 210, 212 based on the input received (such as the average of the quantity of current to the output terminal 204) from the feedback circuit 208.

Because the controller 206 may be responsive to voltages across resistors that are coupled to the output terminal 204, if a conventional inductor were used a discontinuous or reversed current through the conventional inductor may cause an instability in the output regulation loop. If a current flowing through a resistor in the feedback circuit 208 at the output terminal 204 stops or is reversed, then the controller 206 may determine that the voltage at the output terminal 204 should be increased, even if such is not the case. The controller 206 may then adjust the duty cycle by which switches 210, 212 are driven to increase the voltage at the output terminal 204 until expected voltage are realized across the resistor in the feedback circuitry 208. Such loop instability may damage voltage sensitive devices, such as device 222, which may be coupled to the output terminal 204. Such may be remedied by use of the swinging choke 216, rather than a conventional inductor.

The power converter 200 may include an input capacitor 224 electrically coupled between ground GND and the input terminal 202. Power converters 200 typically employ large internal bulk filter capacitors to filter the input power to reduce noise conducted out of the power converter 200, back upstream to the source of the input power. Input capacitor 224 may store charge to facilitate supplying current to the output terminal 204 under medium and high load conditions. The input capacitor 224 may also be coupled between an “inrush” current control block (not shown) and the first active switch 210. The “inrush” current control block is configured to control the “inrush” current that flows to the input capacitor 224, particularly at initial application of the input voltage at input terminal 202.

The power converter 200 may include an output capacitor 218 electrically coupled between ground GND and the output terminal 204. Output capacitor 218 may smooth the output supplied to the output terminal 204.

The swinging choke 216 may be a single component or a network of several discrete components. The swinging choke 216 provides a low inductance path between the node 211 and the output terminal 204 for medium and high current load conditions and may provide a high inductance path between the node 211 and the output terminal 204 for light and no current load conditions. The swinging choke 216 provides a low inductance path at medium and high current load conditions to facilitate fast transient responses to changes in load demands, such as is typical in digital devices. The swinging choke 216 provides a high inductance at light and no current load conditions to maintain continuous current conduction or to decrease reverse current through the swinging choke 216. Maintaining a continuous conduction at the load may be desirable because discontinuities in current conduction at the load may cause instability in the output regulation loop, as discussed above, and may cause increased electromagnetic interference (EMI).

Discontinuities in current conduction typically arise when a power converter stops driving a high side active switch, a low side active switch, or both the high side and low side active switches in order to decrease light load inefficiencies caused by circulating currents. According to existing approaches, a power converter utilizing a synchronous rectifier (without the benefit of a swinging choke) will induce a circulating current when the associated load demand decreases towards zero amps. The synchronous rectifier draws a circulating current from an output capacitor or other storage element through a reverse inductor current into the input terminal through a high side active switch when the high side active switch is turned ON. An input capacitance that may exist in the power converter temporarily stores charge from the circulating current before the high side transistor redistributes the stored charge back to the output capacitor. In an ideal lossless system, the transfer of charge from an output capacitor to an input capacitor and back again in the form of a circulating current during light or no load conditions would not be detrimental to power converter efficiency. However, real circuits dissipate power in the many parasitic resistances. The dissipated power is proportional to the square of the current multiplied by the sum of the parasitic resistances (P_{dissipated}=I²R_{parasitic}).

To reduce the effect of circulating currents some power converters completely disable the synchronous rectifier at light loads or selectively turn off the synchronous converter as the inductor current reaches the zero-crossing point, i.e., the inductor current begins to reverse. Each of these options reduce the issue of circulating currents but do so with many associated costs. For example, selectively shutting down the synchronous rectifier produces discontinuities in the current and results in loop instability and in ringing in the switch voltage waveform, thereby adding EMI to the system. Furthermore, completely disabling the synchronous rectifier at light loads is a forfeiture of range (the ability to supply light load currents), and sensing the zero-crossing point of the inductor current may result in addition of complex circuitry to the power converter.

The swinging choke 216 advantageously decreases the effect of circulating currents inherent in the synchronous rectifier inclusive of controller 206 and active switches 210, 212. The swinging choke 216 provides the inductance to smooth out ripple at both high and medium load currents without reducing efficiency. At light (near-zero) load conditions, the swinging choke 216 also assumes a much larger inductance, preventing the current from becoming discontinuous during this condition. During no load conditions the much larger inductance of the swinging choke 216 provides substantially greater impedance to the circulating currents that would otherwise flow from the output capacitance 218 to the input capacitance on input terminal 202. Thus, by utilizing the swinging choke 216, the power converter 200 substantially reduces or eliminates losses caused by circulating currents and thus operates more efficiently at light (near-zero) and no load conditions without circuitry for sensing the zero-crossing point of swinging choke current and without shutting off the synchronous rectifier.

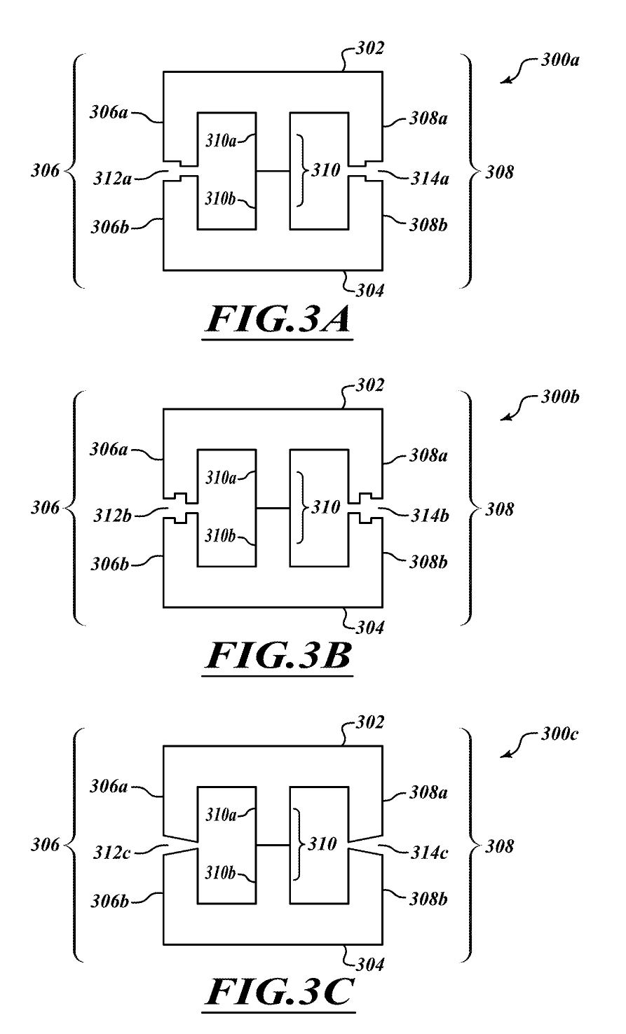

The swinging choke 216 may take a variety of forms. For example, the swinging choke may be constructed with an “E” core, as illustrated in FIGS. 3A, 3B, and 3C. The core of an “E” core swinging choke resembles two capital letter “E's” formed of metal and pressed against one another to form a core which is eventually wound with conductive wire.

FIG. 3A illustrates a swinging choke core 300a, according to one illustrated embodiment. The swinging choke core 300a includes a first E-shaped choke member 302 and a complimentary second E-shaped choke member 304 opposed to the first E-shaped choke member. The E-shaped choke members 302, 304 may be coupled together by any suitable structures or substances. Typically one or more windings (not illustrated in FIGS. 3A-3C) are wound about the E-shaped choke members 302, 304.

The E-shaped members 302, 304 each have a pair of outer leg members 306a, 308a, 306b, 308b, respectively and an inner leg member 310a, 310b. Complimentary pairs of the outer leg members 306a, 306b, 308a, 308b form respective outer legs 306, 308, while the complimentary pair of intermediate leg members 310a, 310b form an intermediate leg 310. The intermediate leg members 310a, 310b may contact one another over a portion thereof. Complimentary outer leg members 306a, 306b, 308a, 308b have a respective gap 312a, 314a located between end portions thereof.

The gap(s) 312a, 314a between the complimentary pairs of outer leg members 306a, 308a, 306b, 308b determine(s) the inductance of the swinging choke 216. The gap 312a, 314a may include at least one step so that part of the gap 312a, 314a is a shorter distance than (i.e., smaller) the remainder of the gap 312a, 314a. The cross-section of the part of the gap having the shorter distance may be smaller than the cross-section of the remaining gap so that the impedance created by the smaller cross-section (the smaller gap, the higher the impedance) saturates quickly under medium and high load conditions.

FIG. 3B illustrates a swinging choke core 300b, according to another illustrated embodiment. The swinging choke core 300b is similar in many respects to that illustrated in FIG. 3A. Similar structures are identified with the same reference number as used in FIG. 3A. Only significant differences are discussed, below.

The swinging choke core 300b differs from the swinging choke core 300 in that gap(s) 312b, 314b includes multiple steps between the end portions of the outer leg members 306a, 308a, 306b, 308b. The multiple steps define the inductance of the swinging choke 300b.

FIG. 3C illustrates a swinging choke core 300c. The swinging choke core 300b is similar in many respects to that illustrated in FIGS. 3A and 3B. Similar structures are identified with the same reference number as used in FIGS. 3A and 3B. Only significant differences are discussed, below.

The swinging choke core 300c differs from the swinging choke cores 300a and 300b in that the end portions of one or both of outer leg members 306a, 308a, 306b, 308b may be beveled relative to a plane passing between the E-shaped members 302, 304 to form a ramp such that the size and distance of the gap(s) 312c, 314c varies linearly as the surfaces are traversed along at least one path.

Accordingly, the inductance of the swinging choke 216 may vary as a function of current flow through the swinging choke 216.

The power converter 200 may include optional preload resistor 220. The preload resistor 220 may cause small amounts of current to flow during no load conditions, i.e., while the device 222 does not draw current. The preload resistor 220 may have a sufficiently high resistance so as not to significantly impact the amount of current supplied to the device 222 during medium and high load conditions. The preload resistor 220 may contribute to additional inefficiencies. However, when combined with the swinging choke 216, the preload resistor 220 may contribute to a net decrease in power inefficiencies at light and no load conditions over existing approaches.

While FIGS. 3A-3C illustrated a gap 312a, 314a, 312b, 314b, 312c, 314c between end portions of each complimentary pair of outer leg members 306a, 308a, 306b, 308b, some embodiments may have a gap between only one pair of the outer leg members.

While each of FIGS. 3A-3C illustrate a swinging choke core 300a, 300b, 300c with an outer leg core configuration, other configurations may be employed. For example, a center post ground core configuration may be employed with a gap formed between the intermediate leg members 310a, 310b, rather than between the outer leg members 306a, 308a, 306b, 308b. The stepped or angled gap may be located between portions of complimentary pieces that form the intermediate leg 310.

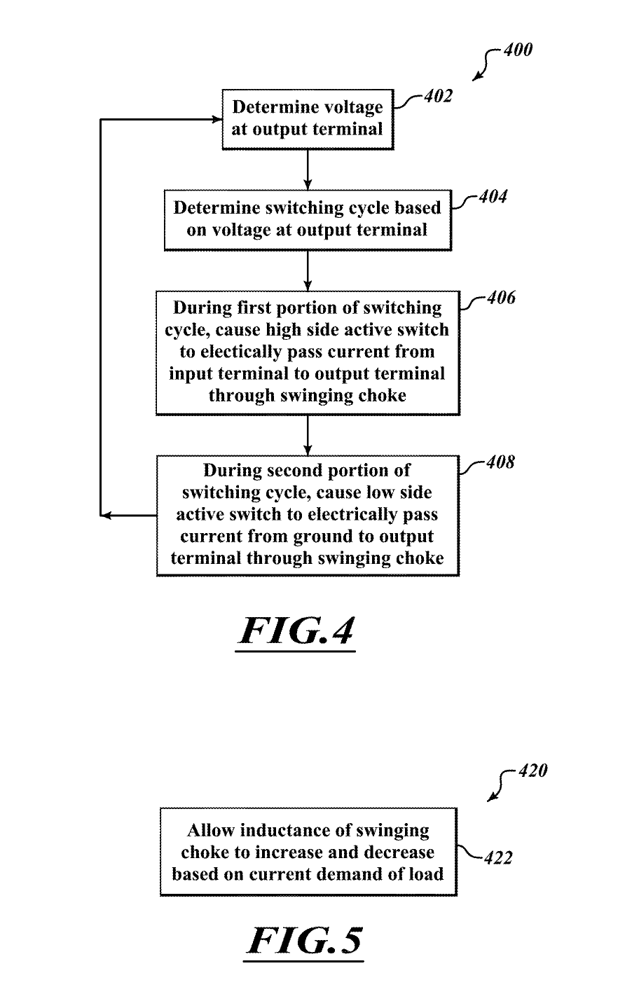

FIG. 4 shows a method 400 of operating the power converter 200 of FIG. 2, according to one illustrated embodiment.

At 402, the feedback circuit 208 determines voltage at an output terminal. For example, the feedback circuit 208 may determine the voltage at the output terminal 204 by comparing a reference voltage within the feedback circuit 208 to a voltage across a sense resistor that is coupled to the output terminal 204. The feedback circuit 208 provides a signal indicative of the sensed voltage to the controller 206. Alternatively, the feedback circuit 208 may determine the current flowing into the output terminal 204 and provide a signal indicative of the determined current to the controller 206.

At 404, the controller 206 determines a switching cycle or frequency based on the voltage at output terminal. The controller 206 may receive a signal indicative of voltage at the output terminal 204 from the feedback circuit 208. The controller may additionally or alternatively receive a signal indicative of the current flowing through the output terminal 204 from the feedback circuit 208. The controller 206 may determine, increase, or decrease the switching cycle (e.g., duty cycle) used to control active switches 210, 212. The switching cycle may be proportional to the regulated voltage at the output terminal 204 so that increases in switching cycle or frequency correspond to increases in the regulated voltage while decreases in switching frequency correspond to decreases in the regulated voltages. The frequencies used by the switching cycle may range from 280 kHz through 600 kHz, according to one embodiment.

At 406, during first portion of switching cycle, the controller 206 causes the high side active switch to electrically pass current from the input terminal to the output terminal through the swinging choke. For example, the controller 206 may drive (turn ON) the first active switch 210 to pass current from input terminal 202 to output terminal 204 through swinging choke 216. During the first portion of the switching cycle, the current supplied to the output terminal 204 by the swinging choke 216 gradually increases.

At 408, during second portion of switching cycle, the controller 206 causes the low side active switch to electrically pass current from ground to the output terminal through the swinging choke 216. Controller 206 may drive (turn ON) the second active switch 212 to pass current from ground GND to the output terminal 204 through the swinging choke 216. During the second portion of the switching cycle the current supplied to the output terminal 204 by the swinging choke 216 is gradually reduced.

By supplying a gradually increasing current in the first portion of the switching cycle and by supplying a gradually decreasing current in the second portion of the switching cycle to the output terminal 204, the active swinging choke 216 supplies an average current that is sufficient to meet the current demands of the device 222.

FIG. 5 shows an additional method 420 that may be performed as part of the method 400 of FIG. 4.

At 422, the power converter 200 allows inductance of the swinging choke 216 to increase and decrease based on current demand of a load. The swinging choke 216 may increase its inductance as the device 222 enters a light load or no load (no current demand) condition to prevent current from reversing through the swinging choke 216 and circulating back through first active switch 210. When the current demand of the device 222 increases, the swinging choke 216 decreases its inductance to become more responsive to the fast transient load currents that are typical to digital loads.

The specific values, such as voltages, used herein are purely illustrative, and are not meant to be in anyway limiting on the scope. Likewise, the arrangements and topologies are merely illustrative and other arrangements and topologies may be employed where consistent with the teachings herein. While specific circuit structures are disclosed, other arrangements that achieve similar functionality may be employed.

The methods illustrated and described herein may include additional acts and/or may omit some acts. The methods illustrated and described herein may perform the acts in a different order. Some of the acts may be performed sequentially, while some acts may be performed concurrently with other acts. Some acts may be merged into a single act through the use of appropriate circuitry. For example, compensation and level shifting may be combined.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to commonly assigned U.S. patent applications:

Ser. No. ______, titled “SELF SYNCHRONIZING POWER CONVERTER APPARATUS AND METHOD SUITABLE FOR AUXILIARY BIAS FOR DYNAMIC LOAD APPLICATIONS” (Atty. Docket No. 480127.409);

Ser. No. ______, titled “INPUT CONTROL APPARATUS AND METHOD WITH INRUSH CURRENT, UNDER AND OVER VOLTAGE HANDLING” (Atty. Docket No. 480127.410);

Ser. No. ______, titled “POWER CONVERTER APPARATUS AND METHOD WITH COMPENSATION FOR CURRENT LIMIT/CURRENT SHARE OPERATION” (Atty. Docket No. 480127.411);

Ser. No. ______, titled “OSCILLATOR APPARATUS AND METHOD WITH WIDE ADJUSTABLE FREQUENCY RANGE” (Atty. Docket No. 480127.412); and

Ser. No. ______, titled “POWER CONVERTER APPARATUS AND METHODS” (Atty. Docket No. 480127.413P1);

all filed on Jul. 18, 2011, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A switch mode power converter, comprising:
a high side active switch;
a low side active switch electrically coupled to the high side active switch at a node;
an inductor that has an inductance that varies as a function of current flow through the inductor, the inductor coupled between an output voltage terminal and the node between the high and the low side switches; and
a controller coupled to control the high and the low side active switches to regulate an output voltage provided by the switch mode power converter, wherein the high side active switch is selectively operable in response to the controller to electrically couple the output voltage terminal to an input voltage terminal through the inductor, and the low side active switch is selectively operable in response to the controller to electrically couple the output terminal to a ground of the switch mode power converter through the inductor.

2. The switch mode power converter of claim 1 wherein the inductor, the high side and the low side active switches are configured as a synchronous buck converter.

3. The switch mode power converter of claim 1 wherein the inductor is a swinging choke.

4. The switch mode power converter of claim 1 wherein the controller is an oscillator driven pulse width modulator configured to operate the high side active switch and the low side active switch based on a duty cycle derived from a feedback controller.

5. The switch mode power converter of claim 1 wherein the controller is an oscillator driven pulse width modulator configured to operate the high side active switch and the low side active switch based on a duty cycle that is dependent upon an average of the quantity of current supplied to the output terminal.

6. The switch mode power converter of claim 1 wherein the high side active switch and the low side active switch are metal oxide semiconductor field effect transistors (MOSFETs).

7. The switch mode power converter of claim 1, further comprising a resistor coupled to the output terminal to preload the inductor with a portion of the current flow through the inductor, wherein the inductor is positioned between the resistor and the low side active switch.

8. A switch mode power converter, comprising:
at least one input terminal;
at least one output terminal;
a synchronous buck converter circuit electrically coupled between the at least one input and the at least one output terminals, including at least a first active switch, a second active switch and a swinging choke coupled between the at least one output terminal and the first and the second active switches; and
a controller coupled to control the first and the second active switches to regulate an output voltage provided by the first power converter.

9. The switch mode power converter of claim 8 wherein the swinging choke includes a core having a number of pieces with a number of windings, at least two of the pieces of the core having at least one stepped gap between respective portions thereof.

10. The switch mode power converter of claim 9 wherein the core includes a first outer leg and a second outer leg, and a first stepped gap is between respective portions that form the first outer leg.

11. The switch mode power converter of claim 9 wherein the core includes a first outer leg and a second outer leg and a second stepped gap is between respective portions that form the second outer leg.

12. The switch mode power converter of claim 10 wherein the core include a center leg positioned between the pairs of outer legs.

13. The switch mode power converter of claim 8 wherein the first active switch is a P-channel metal oxide field effect transistor (MOSFET), the second active switch is an N-channel MOSFET and the swinging choke is electrically coupled between a drain of the P-channel MOSFET and a drain of the N-channel MOSFET.

14. A method of operating a switch mode power converter having a high side active switch, a low side active switch and a swinging choke coupled between an output terminal of the switch mode power converter and a node between the high and low side active switches; the method comprising:
during a first portion of a cycle causing the high side active switch to electrically pass current from an input terminal to an output terminal through the swinging choke to vary an inductance of the swinging choke; and
during a second portion of the cycle causing the low side active switch to electrically pass current through the swinging choke to a ground to vary the inductance of the swinging choke.

15. The method of claim 14 wherein the high side active switch is a high side metal oxide field effect transistor and causing the high side active switch to electrically pass current includes applying a high side gate drive signal to the high side MOSFET and wherein the low side active switch is a low side MOSFET and causing the low side active switch to electrically pass current includes applying a low side gate drive signal to the low side MOSFET.

16. The method of claim 14, further comprising:
in response to a reduction in a level of the current being passed by at least one of the high side or the low side active switches, allowing the inductance of the swinging choke to increase to prevent the current from becoming discontinuous.
